(19) United States
(12) Patent Application Publication
(10) Pub. No.: US 2015/0253950 A1
(43) Pub. Date: Sep. 10, 2015

(54) MANIPULATING DEVICE

(71) Applicant: HONDA MOTOR CO., LTD., Tokyo (JP)

(72) Inventors: Junichiro Onaka, Utsunomiya-shi (JP); Naotoshi Fujimoto, Utsunomiya-shi (JP)

(21) Appl. No.: 14/635,207

(22) Filed: Mar. 2, 2015

(30) Foreign Application Priority Data
Mar. 6, 2014 (JP) 2014-044292

(51) Int. Cl. G06F 3/0487; G06F 3/023

(52) U.S. Cl. CPC G06F 3/0487; G06F 3/023

(57) ABSTRACT

A manipulating device includes a rotating shaft; a rotating member having a predetermined width direction along the rotating shaft; a display unit configured to display a menu configured by an array of a plurality of items or display a predetermined set value; and a control unit configured to execute a first control of selecting an item from the menu according to a rotational manipulation of the rotating member or changing the set value. The manipulating device includes an axial position detecting unit configured to detect a position where a pointing element approaches or contacts the rotating member in a direction intersecting a rotational direction of the rotating member. The control unit executes a second control different from the first control, according to the position detected by the axial position detecting unit.

### CROSS-REFERENCE TO RELATED APPLICATION

Priority is claimed on Japanese Patent Application No. 2014-044292 filed on Mar. 6, 2014, the contents of which are incorporated herein by reference.

### BACKGROUND OF THE INVENTION

1. Field of the Invention

The present invention relates to a manipulating device.

2. Description of Related Art

In the related art, a multifunctional manipulating device for a vehicle provided with a first manipulating device constituted of a bidirectional rotating member that calls and/or selects a functional group and functions within a menu structure shown on a display device, using at least one bidirectional rotating member, and a second manipulating device that additionally calls and/or selects a menu screen is known (for example, refer to Published Japanese Translation No. 2004-513819 of the PCT International Publication).

### SUMMARY OF THE INVENTION

In the manipulating device of the related art, the convenience to the operator may be low.

Aspects related to the invention have been made in consideration of such circumstances, and an object of the invention is to provide a manipulating device that enhances the convenience to the operator.

The invention has adopted the following aspects in order to solve the above problems and achieve the object.

(1) A manipulating device related to an aspect of the invention includes a rotating member having a rotating shaft and a predetermined width direction along the rotating shaft; a display unit configured to display a menu configured by an array of a plurality of items or display a predetermined set value; and a control unit configured to execute a first control of selecting an item from the menu according to a rotational manipulation of the rotating member or changing the set value. The manipulating device includes an axial position detecting unit configured to detect a position where a pointing element approaches or contacts the rotating member in a direction intersecting a rotational direction of the rotating member. The control unit executes a second control different from the first control, according to the position detected by the axial position detecting unit.

(2) As another aspect of the invention, in the manipulating device of (1), the second control may be a selection of another menu that is present within the same hierarchy as the menu, or a selection of a menu that is present in a hierarchy different from that of the menu.

(3) As another aspect of the invention, in the manipulating device of (1) or (2), the axial position detecting unit may detect a continuous change in the position of the pointing element in a direction intersecting the rotational direction in a state where the pointing element has contacted the rotating member, as a movement direction in a state where the pointing element has approached or contacted the rotating member, and the control unit may execute the second control according to the movement direction.

(4) As another aspect of the invention, in the manipulating device of (1) or (2), the axial position detecting unit may divide the rotating member into a plurality of areas in a direction of the rotating shaft, and may detect the position of the approach or contact according to the presence/absence of the approach or contact of the pointing element with respect to the areas.

(5) As another aspect of the invention, in the manipulating device of any one of (1) to (4), the rotating member may include a conductive material, and the axial position detecting unit may include a capacitance sensor that is arranged so that the electrostatic capacity of the rotating member can be detected, and may detect the approach or contact of the pointing element based on a change in the electrostatic capacity that changes as the pointing element approaches or contacts the rotating member.

(6) As another aspect of the invention, in the manipulating device of (5), the rotating member may include a moderation feeling imparting mechanism configured to include ride-over portions that are provided at predetermined intervals in a circumferential direction and a click pin that abuts the ride-over portions with a predetermined biasing force and impart a feeling of moderation at a certain predetermined angle during the rotational manipulation of the rotating member, and may be electrically connected to the capacitance sensor via the click pin.

(7) As another aspect of the invention, in the manipulating device of any one of (1) to (4), the rotating member may be arranged so that the rotating shaft is embedded in a predetermined attachment surface, and the axial position detecting unit may include a capacitance sensor that is arranged on the attachment surface and that is arranged at a position where the pointing element is capable of contacting the capacitance sensor when the rotating member is rotationally manipulated.

(8) As another aspect of the invention, in the manipulating device of (7), the rotating member may be arranged so that the whole rotating member is embedded in the attachment surface, and the capacitance sensor may be arranged in a direction on an extension line of the rotating member in the rotational direction on the attachment surface.

(9) As another aspect of the invention, in the manipulating device of (7), the capacitance sensor may be arranged in a direction on an extension line of the rotating shaft of the rotating member on the attachment surface.

(10) As another aspect of the invention, in the manipulating device of (4), the axial position detecting unit may include a pressure sensor that detects a force applied to the areas in a direction intersecting a circumferential surface of the rotating member, and may detect the contact position of the pointing element based on a pressure that is generated as the pointing element rotationally manipulates or pressingly manipulates the circumferential surface.

(11) As another aspect of the invention, in the manipulating device of (4) or (10), the rotating member may be provided with irregularities so as to visually or haptically discriminate among the plurality of areas.

(12) As another aspect of the invention, in the manipulating device of any one of (1) to (11), the second control may not be reflected in the control unit even if there is any change in a detection state using the axial position detecting unit while the rotational manipulation of the rotating member continues being detected.

(13) As another aspect of the invention, in the manipulating device of any one of (1) to (12), the rotating member may be arranged within a range in which a driver's thumb can reach when gripping the steering wheel, in a spoke portion of a steering wheel of a vehicle.

(14) As another aspect of the invention, in the manipulating device of (13), the control unit may not execute the first control or the second control in a state where the steering wheel is steered at an angle equal to or more than a predetermined angle, in a straight-ahead state of a vehicle or in a state where the steering wheel is steered at an angular velocity equal to or more than a predetermined angular velocity.

(15) As another aspect of the invention, in the manipulating device of any one of (1) to (12), the rotating member may be arranged in a center console of a vehicle within a range where the rotating member is capable of being manipulated in a state where a driver is seated in a driver's seat.

(16) As another aspect of the invention, in the manipulating device of any one of (1) to (15), the control unit may make the display unit perform a display according to an approaching state before execution of the second control, when a state where the pointing element has approached the rotating member with predetermined spacing is detected by the axial position detecting unit before the pointing element contacts the rotating member.

(17) As another aspect of the invention, in the manipulating device of any one of (1) to (9), the axial position detecting unit may be capable of detecting a pseudo-pressing manipulation based on the range of positions where the detected pointing element contacts the rotating member, and the control unit may execute a third control different from the first control and the second control according to the pseudo-pressing manipulation.

(18) As another aspect of the invention, in the manipulating device of (17), the third control may be a determination input for determining an item selected by the first control or the second control.

(19) As another aspect of the invention, in the manipulating device of (18), the control unit may execute the first control when the determination input is received in a case where the first control is item selection from the menu, and may execute the first control before the determination input is received in a case where the first control is a change in the set value.

(20) As another aspect of the invention, in the manipulating device of any one of (1) to (19), when the display unit and the rotating member are in predetermined reference states, a manipulation direction of the rotational manipulation and a manipulation direction of a movement manipulation caused by the approach or the contact may coincide with selection directions according to the first control and the second control in the display unit.

According to the aspects related to the invention, a menu configured by an array of a plurality of items, information indicating a plurality of functions of a selected menu, and information indicating the set value of a selected function can be changed by the rotational manipulation and by the contact or approach of the pointing element to the rotating member. Accordingly, since a selection of items or set values in two dimensions as well as that in one-dimension can be performed, the convenience to the operator can be enhanced.

According to the above aspects (1) and (2), since the control based on rotational manipulation and the control based on the contact or approach of the pointing element to the rotating member is executed, the convenience to the operator can be enhanced.

According to the above aspect (3), since the control based on the movement direction in the state where the pointing element has contacted the rotating member is performed, an operator's intention can be more clearly distinguished and control based on manipulation can be performed.

According to the above aspect (4), since the rotating member 22 is divided into the plurality of areas in the direction of the rotating shaft 24 and the axial position detecting unit 50 detects the position of the approach or contact of the pointing element to the areas, the position of the pointing element can be detected with higher precision. Additionally, it is also possible to detect which portion of the rotating member 22 the pointing element has contacted or approached as consecutive values, and the position of the pointing element can be specified with higher precision.

According to the above aspect (5), since the rotating member 22 includes the conductive material, and the axial position detecting unit 50 includes the capacitance sensor and detects the approach or contact of the pointing element to the rotating member based on the change in the electrostatic capacity, the position of the pointing element can be detected with higher precision.

According to the above aspect (6), when the click pin 70 has the moderation feeling imparting mechanism, an operator's operational feeling can be improved.

According to the above aspect (7), since the capacitance sensor 26 is attached onto the attachment surface 72, simplification of the structure of the manipulating device 10 can be achieved. Additionally, since the pointing element directly contacts the capacitance sensor 26, detection precision is further improved.

According to the above aspect (8), the rotating member 22 is arranged so as to be embedded in the attachment surface 72, and when an operator manipulates the rotating member 22, the operator contacts the capacitance sensor 26. Therefore, an approach or contact position of the pointing element can be more reliably detected.

According to the above aspect (9), since the capacitance sensor 26 is arranged in the direction on the extension line of the rotating shaft 24 of the rotating member 22 on the attachment surface 72, the arrangement of the capacitance sensor 26 is possible even when there is no space where the capacitance sensor 26 is arranged parallel to the rotating shaft 24.

According to the above aspect (10), since the axial position detecting unit 50 includes the pressure sensor, the circuit configuration is simple due to using the capacitance sensor, and simplification of the structure is achieved.

According to the above aspect (11), the rotating member 22 is provided with the irregularities so as to visually or haptically discriminate among the plurality of areas. Therefore, the operator can recognize the areas of the rotating member 22, and an erroneous manipulation is prevented.

According to the above aspect (12), since the second control is not reflected even if there is any change in a detection state using the axial position detecting unit 50 while the rotational manipulation of the rotating member 22 continues being detected, operability is improved.

According to the above aspect (13), since the rotating member 22 is arranged within a range in which a driver's thumb can reach when gripping the steering wheel 14, in the spoke portion 18 of the steering wheel 14 of the vehicle, the operability of the manipulating device 10 is improved.

According to the above aspect (14), since the first control or the second control is not executed in a predetermined state of the vehicle, this can contribute to safe driving. Additionally, an erroneous manipulation of the manipulating device 10 can be prevented.

According to the above aspect (15), since the rotating member 22 is arranged within a range where the rotating member can be manipulated, in the center console 82 of the vehicle, in a state where a driver is seated in a driver's seat, the degree of freedom in the layout of the vehicle is improved.

According to the above aspect (16), since the control unit 40 makes the display unit 19 perform the display according to the approaching state before the execution of the second control perform, occurrence of an erroneous manipulation can be prevented.

According to the above aspect (17), since the third control is executed according to the pseudo-pressing manipulation, the intention for determination of a selection item can be reliably determined, and an erroneous manipulation can be prevented. Additionally, since the intention for determination is determined in a pseudo manner, multiple functions can be achieved at low cost.

According to the above aspect (18), since the third control is the determination input for determining an item selected by the first control or the second control, the intention for determination of a selection item can be reliably determined, and an erroneous manipulation can be prevented.

According to the above aspect (19), since the first control is executed before the determination input is received when the first control is the change in the set value, a determination manipulation regarding the set value that is continuously changed can be eliminated, and the operability of the manipulating device is improved.

According to the above aspect (20), the manipulation direction of the rotational manipulation and the manipulation direction of manipulation caused by the approach or the contact coincide with the selection directions according to the first control and the second control in the display unit. Therefore, the operator can easily understand the manipulation of the manipulating device, and operability is improved.

### BRIEF DESCRIPTION OF THE DRAWINGS

FIG. 1 is a view illustrating an example of an external appearance configuration of a manipulating device 10 related to a first embodiment of the invention.

FIG. 2 is a view illustrating an example of an internal configuration of the manipulating device 10 related to the first embodiment.

FIG. 3 is a view illustrating an example of a position detecting sensor 26 related to the first embodiment.

FIG. 4 is a view illustrating an example of the surface shape of a rotating member 22.

FIG. 5 is a view illustrating an example of a functional configuration provided in the manipulating device 10 related to the first embodiment.

FIG. 6 is a view illustrating an example of a display screen of a display unit 19.

FIG. 7A is a view illustrating an example of the display screen of the display unit 19.

FIG. 7B is a view illustrating an example of the display screen of the display unit 19.

FIG. 7C is a view illustrating an example of the display screen of the display unit 19.

FIG. 7D is a view illustrating an example of the display screen of the display unit 19.

FIG. 7E is a view illustrating an example of the display screen of the display unit 19.

FIG. 7F is a view illustrating an example of the display screen of the display unit 19.

FIG. 8A is a view illustrating an example of the display screen of the display unit 19.

FIG. 8B is a view illustrating an example of the display screen of the display unit 19.

FIG. 8C is a view illustrating an example of the display screen of the display unit 19.

FIG. 9 is a view illustrating an example of the display screen of the display unit 19.

FIG. 10 is a flowchart illustrating an example of a processing flow of the first embodiment.

FIG. 11 is a view illustrating an example of an internal configuration of the manipulating device 10 related to a second embodiment of the invention.

FIG. 12 is a view illustrating an example of an internal configuration of the manipulating device 10 related to a third embodiment of the invention.

FIG. 13 is a view illustrating an example, in a top view, of a switch unit 12 related to a fourth embodiment of the invention.

FIG. 14 is a view illustrating an example, in a top view, of the switch unit 12 related to a fifth embodiment of the invention.

FIG. 15 is a view illustrating an example of the top perspective view of the switch unit 12 related to the sixth embodiment of the invention.

FIG. 16 is a view illustrating an example of a functional configuration provided in the manipulating device 10 related to a seventh embodiment of the invention.

FIG. 17 is a flowchart illustrating an example of a processing flow of the seventh embodiment.

FIG. 18 is a view illustrating an example of an external appearance configuration of the manipulating device 10 related to an eighth embodiment of the invention.

FIG. 19 is a side view illustrating an example of an external appearance configuration of the manipulating device 10 related to the eighth embodiment.

### DETAILED DESCRIPTION OF THE INVENTION

### First Embodiment

[Configuration]

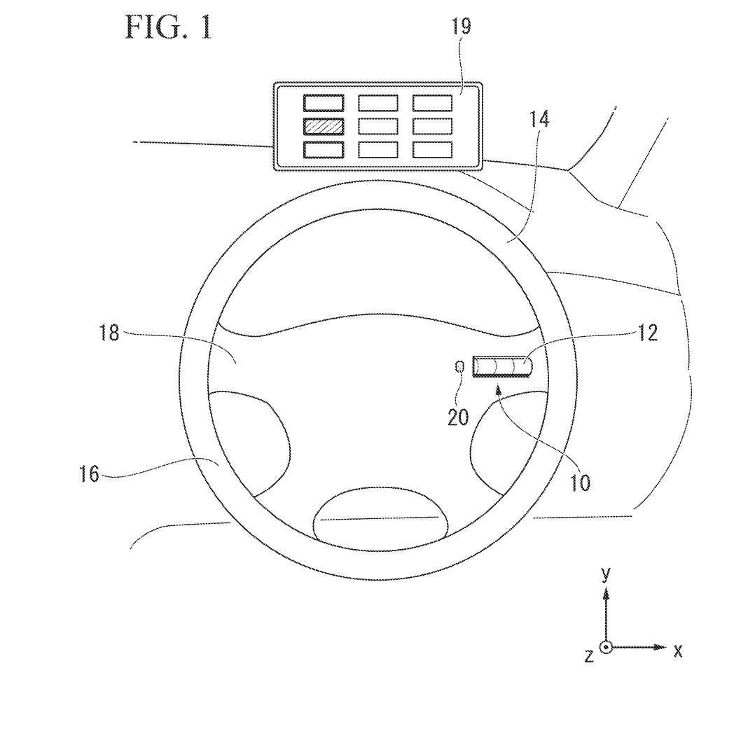

Hereinafter, embodiments of a manipulating device 10 of the invention will be described with reference to the drawings. FIG. 1 is a view illustrating an example of an arrangement of the manipulating device 10 related to the first embodiment is arranged.

As illustrated in FIG. 1, a switch unit 12 of the manipulating device 10 is arranged at a spoke portion 18 that supports a rim portion 16 of a steering wheel 14. The spoke portion 18 is a T-shaped spoke that supports the circular rim portion 16 at a neutral position of the steering wheel 14 illustrated in FIG. 1. A start switch 20 for starting a display unit 19 for displaying information for instruction input is arranged beside the switch unit 12.

The switch unit 12 is arranged at the portion of the spoke portion 18 that is positioned in a substantially horizontal direction (left-right direction in FIG. 1) and supports the rim portion 16, when the steering wheel 14 is at the neutral position. When an operator within a vehicle directs his/her sight line to a forward direction, the switch unit 12 is arranged to face the operator in the vicinity of the rim portion 16 on the right side of the spoke portion 18. In the present embodiment, the operator is, for example, a driver of the vehicle. Additionally, the start switch 20 is arranged in the vicinity of the switch unit 12. The switch unit 12 is arranged within a range where a thumb (first finger) of a right hand can reach and out of a range of a right thumb, when an operator's right hand touches the switch unit in a predetermined hand breadth of the rim portion 16. In addition, arranging the switch unit 12 on the right-hand side is merely an example, and the switch unit 12 may be arranged on a left-hand side, a pair of the switch units may be arranged so as to be capable of being manipulated with both left and right hands, and the switch unit may be arranged on a front side of the spoke portion 18.

Here, “the range where the thumb (first finger) can reach” means within a predetermined range having the root of the thumb as a center and having the length of the thumb (the first finger length) as a radius. It is preferable that the first finger length be a 50 percentile value specified in JM50 of Japan Industrial Standard (JIS) (50 [%] of the total population of adult Japanese men have a thumb shorter than the first finger length) or a 50 percentile value specified in JF50 of JIS (50 [%] of the total population of adult Japanese woman have a thumb shorter than the first finger length).

In addition, the aforementioned “information for instruction input” means a menu configured by an array of a plurality of items, information indicating a plurality of functions of a selected menu, information indicating the set value of a selected function, functions provided in a vehicle-mounted instrument, information displayed by the vehicle-mounted instrument, and the like. The menu configured by the array of a plurality of items is, for example, a menu or the like regarding a vehicle-mounted instrument handled in the same hierarchy. For example, an air conditioner, an audio instrument, a lighting device, a wiper, a condensation removal device, a navigation device, an operation assisting device, a driving safety device, or the like may be included as the vehicle-mounted instrument.

Additionally, for example in a case where the vehicle-mounted instrument is an audio instrument, mode selection functions for selecting modes such as AM, FM, CD, an external instrument such as a memory audio, a hard disk drive (HDD), or the like, audio functions including a sound volume section function, and information for instruction input displayed on a display unit within the vehicle depending on signals from the audio instrument are included as information indicating a plurality of functions of a menu selected in a hierarchy different from that of the menu configured by the array of a plurality of items.

Additionally, the set value of a selected function means a set value to which the operator desires to set a function. For example, if the function of a selected vehicle-mounted instrument is an audio instrument, modes such as AM, FM, CD, an external instrument such a memory audio, a hard disk drive (HDD), and the like, channel numbers of AM and FM, the sound volume, and the like correspond to the set value.

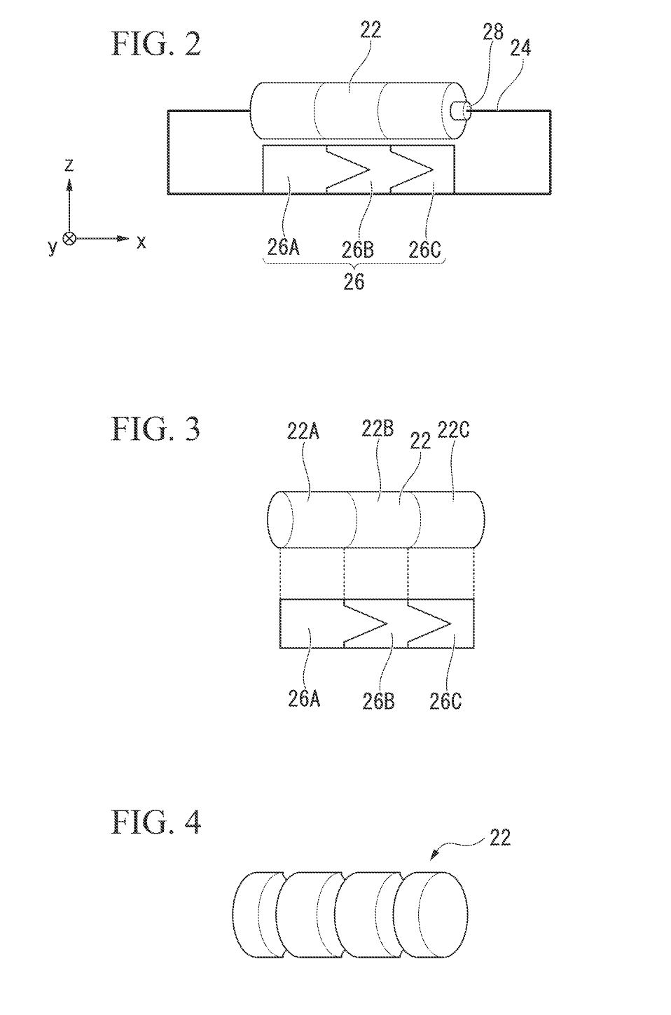

Hereinafter, the switch unit 12 will be described. FIG. 2 is a view illustrating an example of an internal configuration of the manipulating device 10.

The switch unit 12 of the manipulating device 10 is a switch that allows the operator to perform an input manipulation corresponding to an instruction input screen displayed on the display unit 19 within the vehicle. The switch unit 12 is, for example, a rotary switch and includes a rotating member 22 and a rotary encoder 28. The rotating member 22 is rotatably supported around the axis of a rotating shaft 24 that extends, for example, in a direction substantially parallel to the surface of the spoke portion 18, and a portion of an outer peripheral portion of the rotating member 22 protrudes further outward (operator side) than the surface of the spoke portion 18.

The switch unit 12 is manipulated by the operator in a rotational direction from a lower side toward an upper side in a vertical direction or a rotational direction from the upper side toward the lower side in the vertical direction. The rotary encoder 28 outputs, for example, a signal according to the rotational displacement, rotational angle, and rotational direction of the rotating member 22, and a signal including information allowing recognition of the rotational angle of the rotating member 22. An operator's manipulation of rotating the rotating member 22 and performing manipulation, change, or the like of the information for instruction input is referred to as a “rotational manipulation”. In addition, in the switch unit 12, the rotating shaft 24 may be arranged parallel to the vertical direction.

Additionally, the switch unit 12 can detect which position a pointing element (an operator's finger) has approached or touched regarding a direction (X-axis direction in FIG. 2) along the rotating shaft 24. A position detecting sensor 26 having, for example, a plurality of members is attached to face the rotating member 22, on a side opposite to a side of the rotating member 22 (inside of the switch unit 12) where the pointing element approaches or contacts. The position detecting sensor 26 may be, for example, a plurality of capacitance sensors. In this case, the rotating member 22 is suitable if it is a conductive member, and specifically, may be configured by a technique of embedding, fitting, and coating the conductive member with respect to the rotating member 22. When the pointing element approaches the rotating member 22, the electrostatic capacity between the point where the pointing element approaches and each capacitance sensor 26 changes. The plurality of capacitance sensors 26 measures changes in the electrostatic capacity, to thereby detect that the pointing element has approached positions that face the sensors. Therefore, if the pointing element approaches or contacts a specific area of the rotating member 22 that protrudes outward from the surface of the spoke portion 18, a capacitance sensor 26 arranged at a position that faces the pointing element outputs a signal showing that the pointing element has approached or contacted the rotating member.

In addition, the position detecting sensor 26 is suitable if it has the following structure. FIG. 3 is a view illustrating an example of the structure of the position detecting sensor 26. As illustrated in this drawing, the position detecting sensor 26 includes, for example, sensors 26A, 26B, and 26C. If the pointing element approaches or contacts a position (22A in FIG. 3) corresponding to the sensor 26A, only the sensor 26A outputs a signal showing the approach. Additionally, if the pointing element approaches or contacts a position (between 22A and 22B in FIG. 3) corresponding to between the sensors 26A and 26B, the sensor 26A and the sensor 26B output signals showing the approach. By virtue of such a mechanism, the position detecting sensor 26 can detect which position the pointing element (an operator's finger) has touched (or approached) regarding the direction along the rotating shaft 24. Additionally, when each sensor outputs consecutive output values, the position detecting sensor 26 is also able to detect at which position on the rotating member 22 in an axial direction the pointing element has contacted the rotating member 22 as consecutive values. In addition, in the rotating member 22 of FIG. 3, rotating members 22A, 22B, and 22C are electrically insulated.

Additionally, the position detecting sensors 26 may be a plurality of pressure sensors that are embedded inside the rotating member 22 or are installed at the same positions as the sensors 26A to 26C of FIG. 3, as well as the capacitance sensors. Additionally, the position detecting sensor 26 may be, for example, a light reflection sensor that has a light emitting diode (LED) and a phototransistor that are built into the rotating member 22 and that detects a signal when the light from the LED is reflected by the pointing element and the reflected light is received by the phototransistor. Additionally, as the position detecting sensor 26, for example, a temperature sensor that detects the temperature of the pointing element and measures the temperature may be used. It is only necessary for the position detecting sensor 26 to be a position detecting sensor 26 that detects the approach or contact of the pointing element and outputs a signal when the pointing element has approached or contacted the rotating member. Moreover, the position detecting sensor 26 may be of arbitrary types that measure natural physical or chemical quantities and output electrical signals corresponding to the natural quantities.

Additionally, the rotating member 22 of the switch unit 12 may be what can allow the operator to recognize which position thereof the pointing element has touched (or is going to touch) regarding the direction along the rotating shaft 24. For example, the surface of the rotating member 22 may include irregularities that can be visually or haptically distinguished. FIG. 4 is a view illustrating an example of the surface shape of the rotating member 22. The operator can visually recognize the irregularities or contact the irregularities, thereby recognizing which position the pointing element has touched (or is going to touch) regarding the direction along the rotating shaft 24. As a result, the operator can sensuously understand which position the pointing element (finger) has approached or contacted regarding a lateral direction of the rotating shaft 24.

The start switch 20 is a switch for starting the display unit 19. The start switch 20 outputs a signal according to an operator's pressing manipulation. In addition, the start switch 20 may not be provided but the display unit 19 may be controlled so as to be started depending on a predetermined change of the electrostatic capacity in the aforementioned capacitance sensor 26 or a predetermined change of the light-receiving time in the aforementioned light reflection sensor 26.

For example, a control unit 40 to be described below may perform control such that the display unit 19 is started when the predetermined change in the electrostatic capacity is exceeded, utilizing the fact that a change in the electrostatic capacity detected by the position detecting sensor 26 is large, when the approach distance of the pointing element with respect to the rotating member 22 is short or the contact area thereof is large. Additionally, in a case where the position detecting sensor 26 is the light reflection sensor, the control unit 40 to be described below may preform control such that the display unit 19 is started if the predetermined light-receiving time is exceeded, for example utilizing the fact that the time for which the light from an LED is reflected by the pointing element and the reflected light is received by a phototransistor becomes long, if the approach time or contact time of the pointing element with respect to the rotating member 22 becomes long.

In addition, the control unit 40 to be described below may perform the processing of determining a function corresponding to information selected from the menu configured by the array of a plurality of items, the information indicating a plurality of functions of a selected menu, and the information indicating the set value of a selected function, depending on the predetermined change in the electrostatic capacity of the aforementioned capacitance sensor and the predetermined change in the light-receiving time of the aforementioned light reflection sensor.

The display unit 19 is, for example, a head-up display obtained by projection of light onto a front window, a monitor arranged in an instrument panel, or the like. In FIG. 1, the display unit 19 is described as the head-up display. For example, if the start switch 20 is manipulation by pressing by the operator and a control signal is output from the signal processing unit 44, the display unit 19 is started based on the output control signal, and the information for instruction input is displayed on the display unit 19.

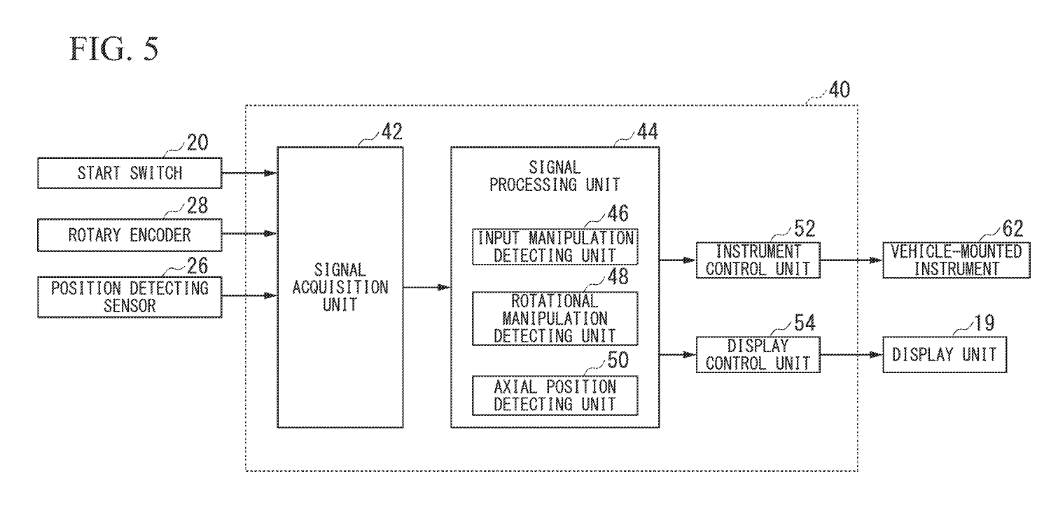

FIG. 5 is a view illustrating an example of a functional configuration provided in the manipulating device 10.

The control unit 40 includes, for example, a signal acquisition unit 42, a signal processing unit 44, an instrument control unit 52, and a display control unit 54. Some or all of these functional units are software functional units that function when a processor of the control unit executes a control program. In addition, some or all of the functional units may be hardware functional units, such as a large scale integration (LSI) and an application specific integrated circuit (ASIC).

The signal acquisition unit 42 acquires signals output from the rotary encoder 28, the position detecting sensor 26, and the start switch 20. The signal processing unit 44 outputs control signals that instruct the operation of the instrument control unit 52 and the display control unit 54, based on the signals acquired by the signal acquisition unit 42. The signal processing unit 44 includes, for example, an input manipulation detecting unit 46, a rotational manipulation detecting unit 48, and an axial position detecting unit 50.

The input manipulation detecting unit 46 acquires, for example, information, such as the output timing of a signal output from the switch unit 12 or the start switch 20 or the manipulation duration time of an input manipulation performed with respect the switch unit 12 or the start switch 20 by the operator.

The rotational manipulation detecting unit 48 detects the rotational displacement, rotational angle, rotational direction, or the like of the rotating member 22, based on a signal output from the rotary encoder 28 of the manipulating device 10. The axial position detecting unit 50 detects at which position along the rotating shaft 24 the pointing element has approached or contacted the rotating member 22, based on the signal output from the position detecting sensor 26. Hereinafter, the manipulation of causing the position detecting sensor 26 to output a signal, by the approach or contact of the pointing element with respect to the rotating member 22, the movement of the pointing element in an approaching state, and the movement of the pointing element in a contacting state, is referred to as a “movement manipulation”. In a touch panel or a touch screen of a smart phone, a tablet terminal, or the like, a flick manipulation of lightly flicking the touch panel or the touch screen to manipulate the touch panel or the touch screen with a fingertip or the like is included in the movement manipulation. Additionally, in the touch panel or the touch screen of the smart phone, the tablet terminal, or the like, the swipe manipulation of manipulating the touch panel or the touch screen by lateral sliding while a finger remains touching or the like is included in the movement manipulation. The signal processing unit 44 processes signals output from the input manipulation detecting unit 46, the rotational manipulation detecting unit 48, and the axial position detecting unit 50, to output control signals to the instrument control unit 52 and the display control unit 54.

The instrument control unit 52 controls a vehicle-mounted instrument 62, based on a control signal output from the signal processing unit 44. Additionally, the display control unit 54 controls a display unit 19, based on a control signal output from the signal processing unit 44. Hereinafter, the control based on the manipulation detected by the rotational manipulation detecting unit 48 is referred to as a “first control”, and the control based on the manipulation detected by the axial position detecting unit 50 is referred to as a “second control”.

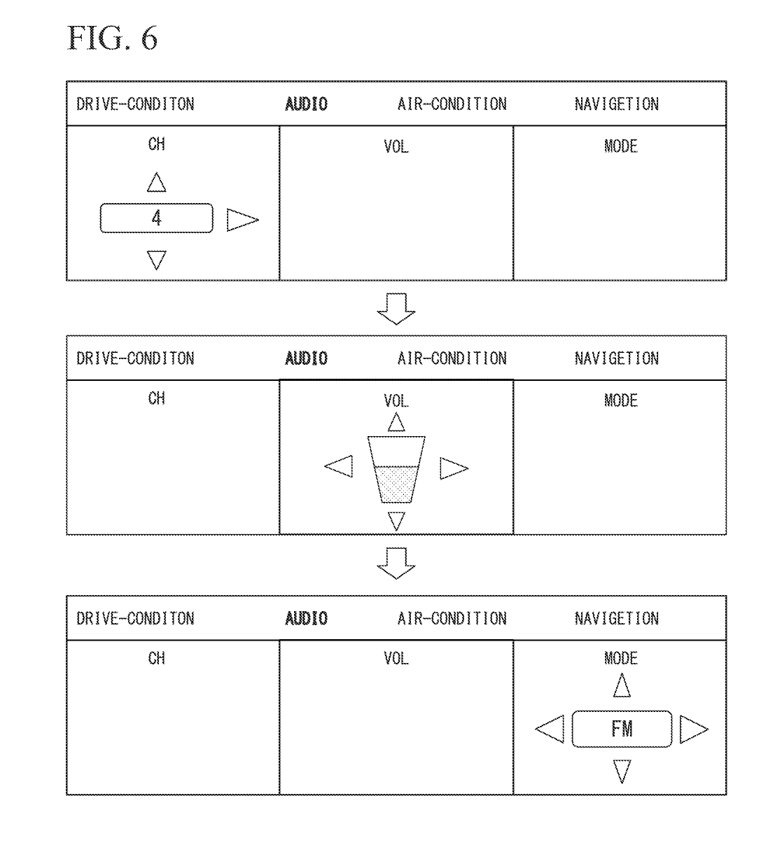

FIG. 6 is a view illustrating an example of change of a display screen to be displayed by the display control unit 54. In the example of FIG. 6, selection items that can be selected by the operator are sequentially switched according to the “movement manipulation”.

An upper figure of FIG. 6 is an example of a display screen of the display unit 19 on which information on the functions of an audio instrument is displayed. information indicating radio channels (CH) on AM or FM bands, information indicating sound volume (Vol), and information indicating modes (MODE) such as AM, FM, and CD, an external instrument such as a memory audio, a hard disk drive (HDD), or the like, are displayed from a left side toward a right side on this display screen.

This type of information can be selectively input simply by making the pointing element approach or contact the area of the rotating member 22 corresponding to a selection item desired by the operator. For example, when it is desired to change broadcast channels (CH), selection and input of a broadcast channel is possible by making the pointing element approach or contact an area (FIG. 3, 22A) of the rotating member 22 corresponding to the broadcast channel (CH) on the display screen. Similarly, when a selection item such as volume is intended to be selected, it is simply necessary to make the pointing element contact or approach an area (FIGS. 3, 22B) of the rotating member 22 corresponding to a selective input of the volume (Vol). Additionally, when a mode (MODE) that is a selection item is intended to be selected, it is simply necessary to make the pointing element contact or approach an area (FIGS. 3, 22C) of the rotating member 22 corresponding to a selective input of the mode (MODE). Moreover, when the set value of a selected item is changed from a state where a desired selection item is selected by approach or contact of the pointing element, the set value can be changed by performing a rotational manipulation as will be described below. That is, a selection item displayed on the display screen and a specific area of the rotating member 22 are matched with each other. For this reason, the selection item corresponding to a specific area of the rotating member 22 can be selectively input by making the pointing element approach or contact the specific area of the rotating member 22. The operator can perform selection of an arbitrary selection item simply by making the pointing element approach or contact a specific area of the rotating member 22.

Additionally, the set value of the set selection item can be changed by a rotational manipulation. As a result, when information for hierarchized instruction input is selected, a separate manipulation for hierarchical movement is unnecessary, and operability is improved.

In addition, these kinds of information may be sequentially switched according to the movement manipulation (the flick manipulation, the swipe manipulation, and the like), in order to more clearly reflect an operator's manipulation intension. For example, if the movement manipulation is performed rightward when a broadcast channel (CH) is selected, as illustrated in a middle figure of FIG. 6, the selectable selection items move to the selection item of the volume (Vol).

If the movement manipulation further rightward is performed from this state, as illustrated in a lower figure of FIG. 6, the selectable items move from the selection item of the volume (Vol) to a selection item of a mode (MODE). In this way, the selectable selection items may sequentially move depending on the movement manipulation.

Additionally, for example, set values set for setting items are changed according to the rotational manipulation of the rotating member 22. For example, in the broadcast channels (CH) set in the audio instrument, the broadcast channels (CH) are sequentially changed according to the rotational manipulation of the rotating member. Additionally, for example, in the volume set in the audio instrument, the volume is sequentially changed according to the rotational manipulation of the rotating member. Additionally, for example, in the modes (MODE) set in the audio instrument, the modes are sequentially changed to the items, such as AM, FM, and CD, according to the input manipulation of the rotating member. Thus, the audio instrument of the vehicle-mounted instrument 62 is controlled so as to satisfy set values that are set with respect to the selection items.

Additionally, when the audio instrument of the vehicle-mounted instrument 62 is controlled so as to satisfy the set values set in the selection items, the audio instrument may be controlled by outputting signals that determine setting of the selection items, depending on the predetermined change in the electrostatic capacity of the aforementioned capacitance sensor 26, the predetermined change of the light-receiving time of the light reflection sensor, and the predetermined pressure change of the pressure sensor. In addition, the manipulation direction of the rotational manipulation and the movement direction of the movement manipulation, and the directions of the change, switching, and selection of the menu, the setting items, and the set values in the display unit 19 may be coincide with each other or may not coincide with each other.

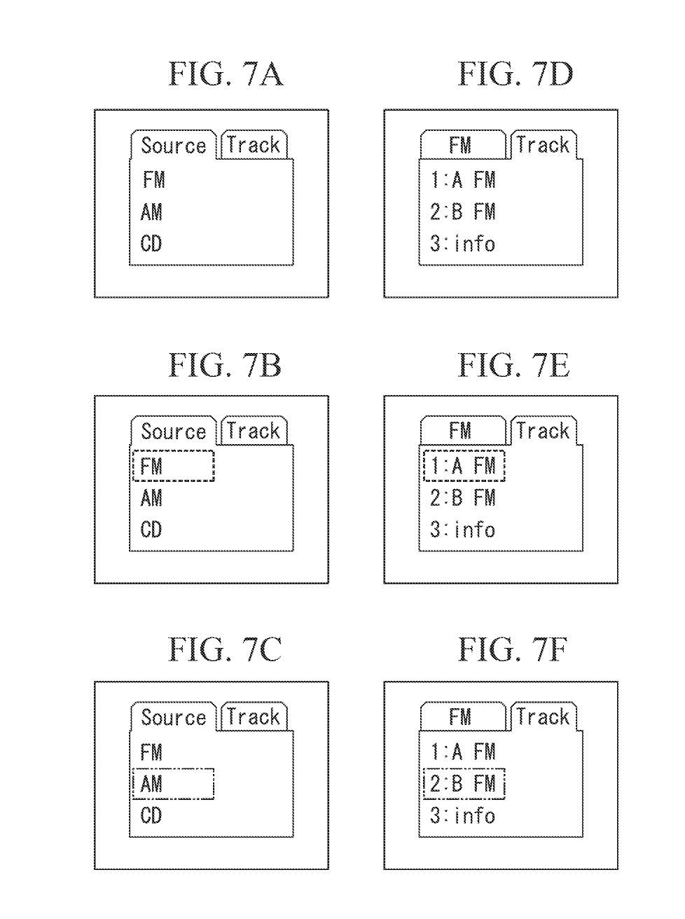

Next, an example of control performed by the manipulation of the switch unit 12 will be described with reference to FIGS. 7A to 7F. FIGS. 7A to 7F are views illustrating an example of the manipulation of the switch unit 12 and the control of the vehicle-mounted instrument 62 and the display unit 19. For example, if a finger is made to approach the rotating member 22, as illustrated in FIG. 7A, selection items regarding the functions of the audio instrument are displayed on the display unit 19. In this state, if a predetermined time passes, as illustrated in FIG. 7B, a state where “FM” that is a function of the audio instrument can be selected is brought about. In this case, if the operator rotates the rotating member 22 downward, the selectable function of the audio instrument is changed from “FM” to “AM”.

Additionally, if the pointing element is made to approach or contact the rotating member 22 so as to move the pointing element in the direction (X direction in FIG. 1) of the rotating shaft 24 in a state where the selection items of the audio instrument are displayed as illustrated in FIG. 7A and “FM” is selected as the function of the audio instrument as illustrated in FIG. 7B, an item group “source” of selection functions consisting of “FM”, “AM”, and “CD” moves to a selection function item group “Track” that selects a receiving channel or a piece of music. Then, a receiving channel “A FM” selected as illustrated in FIG. 7E is displayed, if there is no the movement of the pointing element in the direction of the rotating shaft 24 (X direction in FIG. 1) in the rotating member 22 for a predetermined time. The receiving channel is changed to “B FM” if the rotating member 22 is rotated from this state. Then, if there is no rotation of the rotating member 22 for a predetermined time, the movement manipulation becomes possible.

According to the control described above with reference to FIGS. 7A to 7F, since the control of the vehicle-mounted instrument 62 and the display unit 19 can be performed by the manipulation of the switch unit 12, the functions, setting values, or the like of the vehicle-mounted instrument 62 can be intuitively controlled.

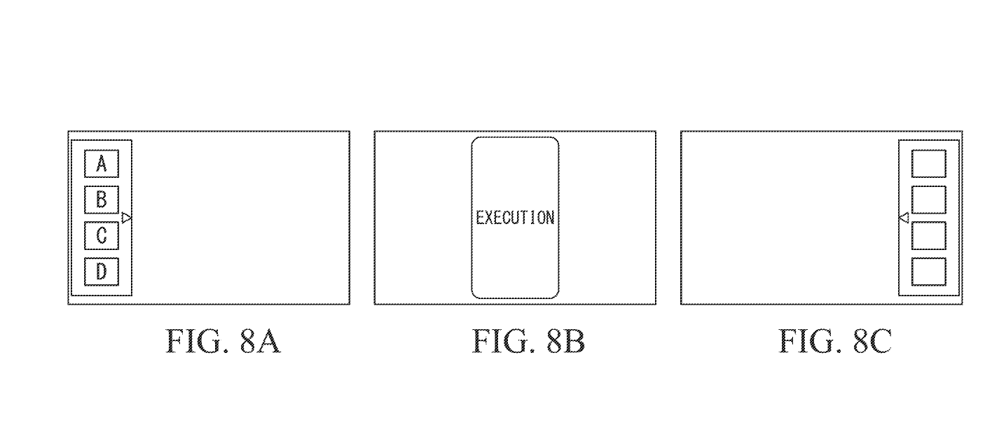

Next, an example of control performed by the manipulation of the switch unit 12 will be described with reference to FIGS. 8A to 8C. FIGS. 8A to 8C are views illustrating examples of the manipulation of the switch unit 12 and the control of the vehicle-mounted instrument 62 and the display unit 19. For example, in an initial state, as illustrated in FIG. 8A, the menu of the vehicle-mounted instrument 62 from A to D is displayed on the left side of the display unit 19. When a selected menu item is executed, as illustrated in FIG. 8B, the display of the display unit 19 is changed and the selected menu item is executed, by moving the pointing element to the center of the rotating member 22 in the direction (X direction in FIG. 1) of the rotating shaft 24. Moreover, if the pointing element is moved to the right side of the rotating member 22, sub-menus of the selected menu item are displayed on the display unit 19, and manipulation for selection becomes possible.

According to the control described above with reference to FIGS. 8A to 8C, since the control of the vehicle-mounted instrument 62 and the display unit 19 can be performed by the manipulation of the switch unit 12, the functions, setting values, or the like of the vehicle-mounted instrument 62 can be intuitively controlled. Moreover, since the manipulation of executing the selected menu item can also be performed by the movement manipulation of the pointing element, the menu, functions, setting values, or the like of the vehicle-mounted instrument 62 can be intuitively and easily controlled.

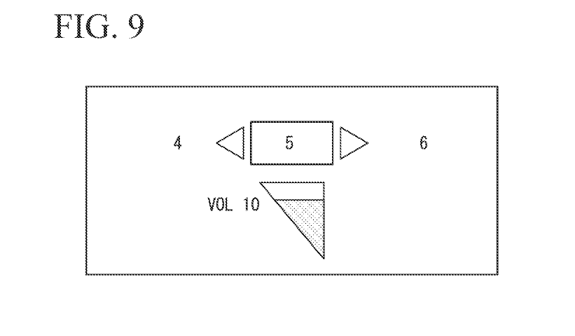

Next, an example of control by the manipulation of the switch unit 12 will be described with reference to FIG. 9. FIG. 9 is a view illustrating an example of the manipulation of the switch unit 12 and the control of the vehicle-mounted instrument 62 and the display unit 19.

For example, as illustrated in FIG. 9, a selected “TRACK” indicating a selected piece of music and a selected “volume” are displayed on the display unit 19. When these two set values are changed, for example, the “TRACK” can be changed by the movement manipulation of a finger in the direction (X direction in FIG. 1) of the rotating shaft 24 with respect to the rotating member 22, and the volume can be adjusted by the rotational manipulation of the rotating member 22 with a finger.

According to the control described above with reference to FIG. 9, the display unit 19 is made to display the two different selection items, and the set values of the selection items can be controlled by the rotational manipulation of the rotating member 22 and the movement manipulation in the rotating member 22. The two kinds of control can be easily executed without changing the display unit 19, and a burden on operator can be eliminated.

[Operation Flow]

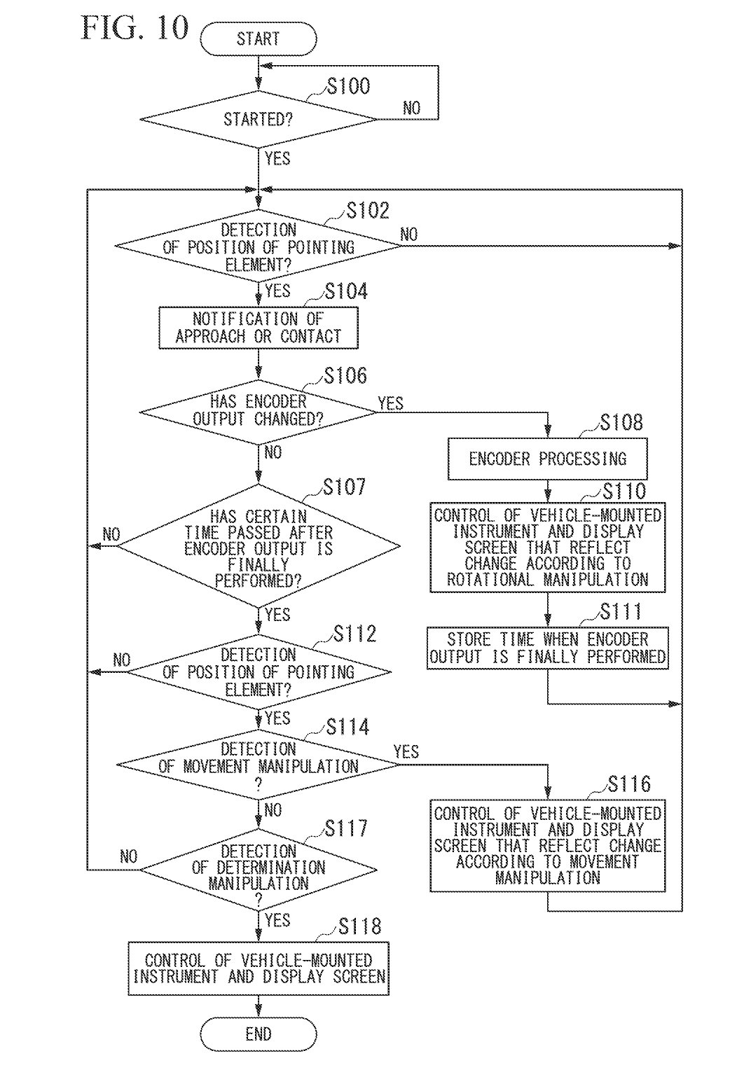

FIG. 10 is a flowchart illustrating an example of a flow of processing executed by the control unit 40 of the present embodiment. First, the input manipulation detecting unit 46 determines whether or not the signal of the start switch 20 has been input (Step S100). If the signal of the start switch 20 has been input, the processing of the control unit 40 proceeds to Step S102.

Next, the axial position detecting unit 50 determines whether or not there is any approach or contact of the pointing element to the rotating member 22 (Step S102). When there is any approach or contact of the pointing element to the rotating member 22, the display control unit 54 performs the control of bringing about a state where the operator of the manipulating device 10 can recognize that the manipulation of the switch unit 12 is possible (Step S104). The above state is, for example, a state where the display unit 19 is turned on or turned off, a state where information for a specific instruction input corresponding to a position where the pointing element has approached or contacted the rotating member 22 is selected, or the like.

Next, the rotational manipulation detecting unit 48 determines whether or not there is any rotational manipulation of the switch unit 12 (Step S106). The processing of the control unit 40 proceeds to Step S108 to be described below when there is any rotational manipulation. When there is no rotational manipulation for a predetermined time, the control unit 40 determines whether or not a certain time has passed since the rotary encoder 28 has last output (Step S107). If the certain time has not passed since the rotary encoder 28 has last output, the processing returns to Step S102. If the certain time has passed, the processing proceeds to Step S112. In this way, the control unit 40 may not receive any movement manipulation and determining manipulation, for a certain time from the end of the rotational manipulation. Additionally, the control unit 40 may not receive any movement manipulation while the rotational manipulation continues.

Next, based on the signal output from the rotary encoder 28 of the switch unit 12, the rotational manipulation detecting unit 48 performs encoder processing and calculates the rotational displacement, rotational angle, rotational direction, or the like of the switch unit 12 (Step S108). Next, the display control unit 54 controls the display unit 19 such that a display screen on which changes of the selection items or the set values according to the rotational manipulation are reflected is displayed (Step S110). Then, the rotational manipulation detecting unit 48 memorizes a time when the encoder has last output (Step S111).

Next, the axial position detecting unit 50 determines whether or not there is any approach or contact of the pointing element to the rotating member 22 (Step S112). If there is no approach or contact of the pointing element to the rotating member 22, the processing of the control unit 40 returns to Step S102. If there is approach or contact of the pointing element to the rotating member 22, the axial position detecting unit 50 determines whether the movement manipulation of the pointing element has been performed as the position of the pointing element that faces the rotating member 22 changes (Step S114). When the movement manipulation has been performed, the display control unit 54 controls the display unit 19 such that a display screen on which the changes of the selection items or the set values according to the movement manipulation are reflected is displayed (Step S116).

Next, the axial position detecting unit 50 detects the position of the pointing element that faces the rotating member 22, and determines whether or not a determination manipulation (to be described below) has been performed (Step S117). When the determination manipulation has not been performed, the processing of the control unit 40 returns to Step S102. When the determination manipulation has been performed, the instrument control unit 52 executes the control of an instrument corresponding to a selection item selected at that time, and/or a set value (Step S118).

Here, the “determination manipulation” is the manipulation of determining that the operator executes information indicating a specific menu or a specific function and a predetermined set value, from the menu configured by the array of a plurality of items, the information indicating a plurality of functions of a selected menu, the information indicating predetermined set value of a selected function, and the like. That is, the control unit 40 executes the control (a third control) of an instrument corresponding to the selected item or the selected set value if the determination manipulation of determining the selected item and the set value is performed. As an example of the control determined by the instrument control unit 52 and the display control unit 54, there is a control of changing a broadcast channel (CH) that is a set value through the rotational manipulation and determining execution of the changed broadcast channel (CH), when the broadcast channel (CH) is selected as a selectable selection item, in a state where a function of the audio instrument is selected on the display unit.

In addition, the determination the of presence/absence of the determination manipulation is, for example, determining that the determination manipulation has been performed, for example, when a change in the electrostatic capacity equal to or higher than a predetermined value has been detected within a predetermined time, when a change in electrostatic capacity has been detected a plurality of times within a predetermined time within a predetermined area, or the like. However, this determination can be appropriately changed. Moreover, when a predetermined pressure against the rotating member has been detected by the pressure sensor, it may be determined that the determination manipulation has been performed. Additionally, regarding the manipulation of adjusting set values, in particular, an instrument corresponding to the set values may be immediately controlled without waiting for execution of a manipulation equivalent to the determination manipulation.

According to the manipulating device 10 of the present embodiment described above, the menu configured by the array of a plurality of items, the information indicating a plurality of functions of a selected menu, and the information indicating the set value of a selected function can be changed by the rotational manipulation and the movement manipulation, and execution of a selected menu item or information can be determined. Accordingly, since a selection of items or set values in two dimensions as well as that in one-dimension can be performed, the convenience to the operator can be enhanced.

### Second Embodiment

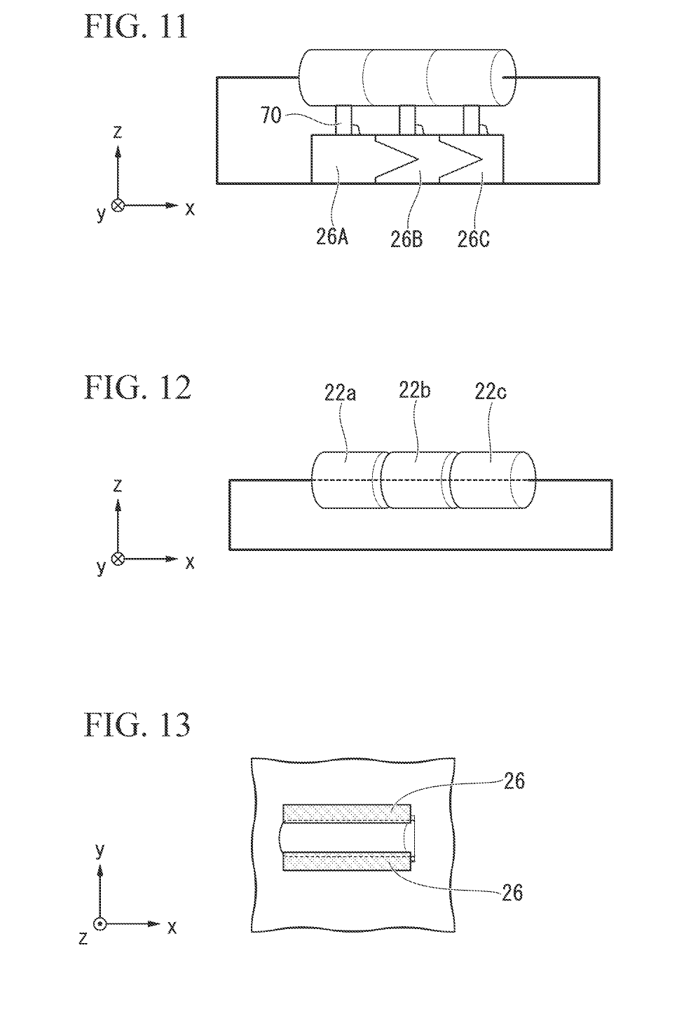

Hereinafter, a manipulating device 10 related to a second embodiment will be described with reference to FIG. 11. FIG. 11 is a view illustrating an example of an internal configuration of the manipulating device 10 related to the second embodiment. The manipulating device 10 illustrated in FIG. 11 includes a click pin 70 in addition to the configuration of the first embodiment. The click pin 70 is attached to face the rotating member 22, on the side opposite to the side (the inside of the switch unit 12) where the pointing element approaches or contacts the rotating member 22. Ride-over portions are provided at predetermined intervals at an outer edge portion of the rotating member 22, and the click pin 70 abuts the ride-over portions with a predetermined biasing force. The click pin 70 abuts against the ride-over portions (concave and convex portions) (not shown), which are provided at the predetermined intervals at the outer edge portion of the rotating member 22 in a circumferential direction, with the predetermined biasing force. The click pin 70 and the ride-over portions configure a moderation feeling imparting mechanism that imparts a feeling of moderation at predetermined angle intervals during the rotational manipulation of the rotating member 22.

The capacitance sensor 26 is provided on a side below the click pin 70, and the capacitance sensor 26 is electrically connected to the click pin 70. If the pointing element approaches or contacts the rotating member 22, a change occurs in the electrostatic capacity of the rotating member 22, and the change is transmitted to the click pin 70 that abuts the rotating member 22. Moreover, since the click pin 70 is electrically connected to the capacitance sensor 26, the capacitance sensor 26 detects this change in the electrostatic capacity, and outputs a signal showing that the pointing element has approached or contacted the rotating member. The axial position detecting unit 50 can specify the position of the pointing element that faces the rotating member 22 from the output signal.

In the manipulating device 10 of the second embodiment described above, an operator's operational feeling can be improved because the click pin 70 and the ride-over portions configure the moderation feeling imparting mechanism, in addition to exhibiting the same effects as the first embodiment.

### Third Embodiment

Hereinafter, a manipulating device 10 to which the present embodiment related to a third embodiment is applied will be described with reference to FIG. 12. FIG. 12 is a view illustrating an example of an internal configuration of the manipulating device 10. The manipulating device 10 illustrated in FIG. 12 is different from the first embodiment in that three rotating members 22 (FIGS. 12, 22a, 22b, and 22c) including a position detecting sensor function are provided as the rotating member 22. Additionally, in the first embodiment, the position detecting sensor 26 provided separately from the rotating member 22 outputs a signal corresponding to the position of the pointing element. In the third embodiment, however, the rotating member 22 including the position detecting sensor function has a mechanism that outputs a signal corresponding to the position of the pointing element that faces the rotating member 22.

In the manipulating device 10 of the third embodiment described above, for example, the rotating members 22a, 22b, and 22c serve as the position detecting sensor 26 as illustrated. If the pointing element approaches or contacts a position (FIG. 12, 22a) corresponding to the rotating member 22a, only the rotating member 22a outputs a signal showing the approach. Additionally, if the pointing element approaches or contacts a position (FIG. 12, between 22a, and 22b) corresponding to between the rotating members 22a and 22b, the rotating member 22a and the rotating member 22b output signals showing the approach. By virtue of such mechanism, the position detecting sensor 26 can detect which position the pointing element (an operator's finger) has touched (or approached) regarding the direction (X-axis direction in FIG. 12) along the rotating shaft 24. Accordingly, the manipulating device 10 can detect the position and movement of the pointing element with higher precision, and instrument control and display control according to the operation of the pointing element can be performed with higher precision. Additionally, since it is not necessary to provide the position detecting sensor 26 separately from the rotating member 22, manufacture and assembling of the manipulating device 10 are also easy.

### Fourth Embodiment

Hereinafter, a manipulating device 10 related to a fourth embodiment will be described with reference to FIG. 13. FIG. 13 is a view illustrating an example, in a top view, of a switch unit 12 related to a fourth embodiment. The switch unit 12 illustrated in FIG. 13 is different from that in the first embodiment in that a position detecting sensor 26 having a longitudinal surface parallel to the rotating shaft of the rotating member 22, is provided on the side of the rotating member 22 (outside of the switch unit 12) where the pointing element approaches, instead of the position detecting sensor 26 described in the first embodiment.

In the manipulating device 10 related to the fourth embodiment, the movement manipulation is detected by detecting that the position of approach or contact to the position detecting sensor 26 moves as the pointing element moves in the axial direction of the rotating member 22. Accordingly, the manipulating device 10 can detect the position and movement of the pointing element with higher precision, and the instrument control and the display control according to the operation of the pointing element can be performed with higher precision. Additionally, even when there is no space in a depth direction where the position detecting sensor 26 is arranged, the position detecting sensor 26 can be arranged on the upper surface or lower surface of the rotating member 22 in the rotational direction (Y direction in FIG. 13).

In addition, the position detecting sensor 26 provided in the vicinity of the outer edge portion of the rotating member 22 may be provided on any one of the upper surface and the lower surface of the rotating member 22 in the rotational direction (Y direction in FIG. 13).

### Fifth Embodiment

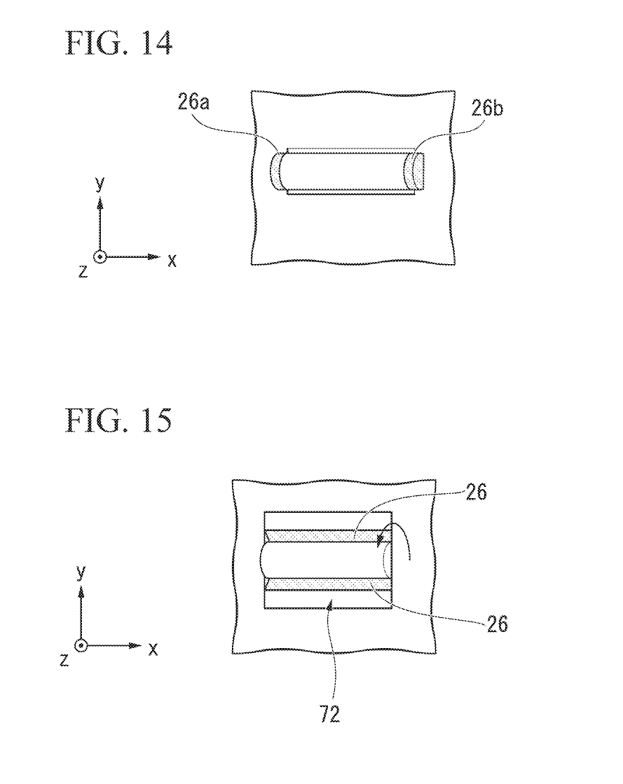

Hereinafter, a manipulating device 10 related to a fifth embodiment will be described with reference to FIG. 14. FIG. 14 is a view illustrating an example, in a top view, of a switch unit 12 related to a fifth embodiment. The manipulating device 10 illustrated in FIG. 14 is different from a first embodiment in that position detecting sensors 26a and 26b are provided in the vicinity of both ends of the rotating shaft 24 of the rotating member 22 instead of the position detecting sensor 26 described in the first embodiment.

If the operator performs the movement manipulation from the left to the right, the position detecting sensor 26a first detects approach or contact of the pointing element and the position detecting sensor 26b then detects approach or contact of the pointing element.

Contrary to this, if the operator performs the movement manipulation from the right to the left, the position detecting sensor 26b first detects approach or contact of the pointing element and the position detecting sensor 26a then detects approach or contact of the pointing element. In the manipulating device 10 related to the fifth embodiment, the operator's movement manipulation is detected according to such a principle.

In addition, instead of the position detecting sensors 26 provided at both left and right ends of the rotating member 22, one position detecting sensor 26 may be provided in the vicinity of either the left end or the right end of the rotating member 22. Additionally, the “vicinity” herein means a position where the axial position detecting unit 50 can detect whether the pointing element performs an approach movement or contact movement, when the pointing element has performed a large movement manipulation of the switch unit 12. For example, when the capacitance sensor 26 is used as the position detecting sensor 26, the position detecting sensors 26 in the vicinity of the left and right ends of the rotating member 22 in a direction parallel to the rotating shaft 24 of the rotating member 22 just have to be located at positions where changes in electrostatic capacity when the pointing element has performed approach movement or contact movement can be detected.

### Sixth Embodiment

Hereinafter, a manipulating device 10 related to a sixth embodiment will be described with reference to FIG. 15. FIG. 15 is a view illustrating an example, in a top perspective view, of a switch unit 12 related to a sixth embodiment. The sixth embodiment is different from the first embodiment in that the rotating member 22 is attached to an attachment surface 72 illustrated in FIG. 15. The attachment surface 72 is provided with a recess and is further provided with a contact detecting mechanism, such as the capacitance sensor. The rotating member 22 is arranged in the recess in a rotatable state so that the operator can manipulate the switch unit 12 with the pointing element. Additionally, a wall extending from a bottom surface of the recess is erected so as to exceed the diameter of the rotating member 22, and the position detecting sensor 26 is provided in the wall so as to face the rotating member 22.

Since the rotating member 22 is arranged in the recess of the attachment surface 72 and the wall of the recess is provided with the position detecting sensor 26, the pointing element directly contacts the position detecting sensor when the operator has performed the movement manipulation. Accordingly, the manipulating device 10 of the present embodiment can detect the position and movement of the pointing element with higher precision, and the control of the vehicle-mounted instrument 62 and the display unit 19 is possible with higher precision.

In addition, the wall can be appropriately selected to be erected from four surfaces of left and right and upper and lower surfaces, and the arrangement position of the position detecting sensor 26 with respect to the erected wall can also be appropriately selected.

### Seventh Embodiment

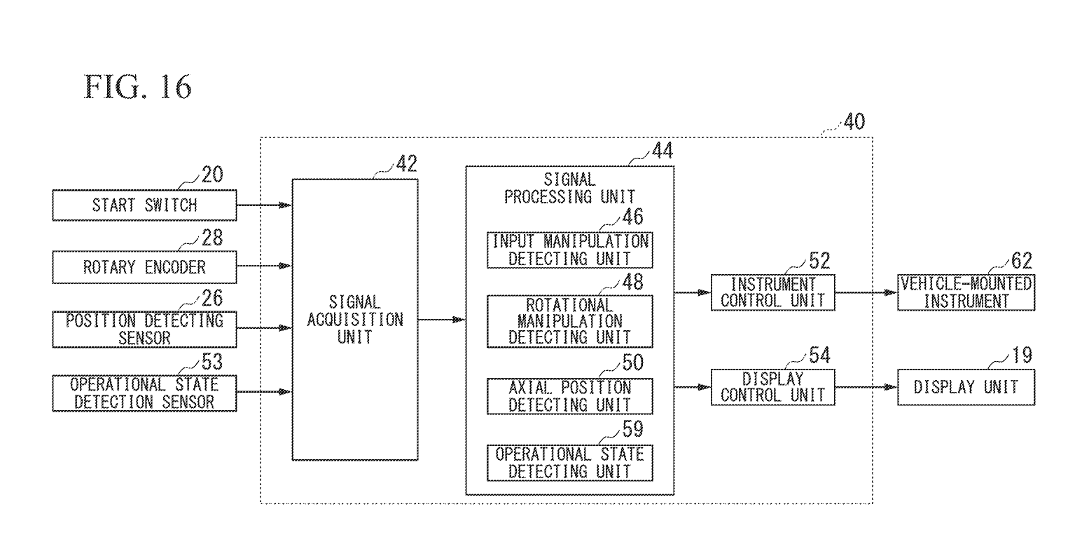

Hereinafter, a manipulating device 10 related to a seventh embodiment will be described with reference to FIG. 16. The manipulating device 10 related to the seventh embodiment is different from the first embodiment in that an operational state detection sensor 53 and an operational state detecting unit 59 are provided. As the operational state detection sensor 53, a sensor that detects the steering angle of the steering wheel, a vehicle speed sensor, a sensor that detects the position of an obstacle around the vehicle, or the like is used. The operational state detection sensor 53 outputs a signal corresponding to a case where a predetermined operational state is brought about, for example, (1) when the steering wheel is steered at an angle equal to or more than a predetermined angle from a neutral position, (2) when the steering wheel is steered at an angular velocity equal to or more than a predetermined angular velocity, (3) when the distance between the vehicle including the manipulating device 10, and a surrounding object becomes equal to or less than a predetermined spacing, (4) when the acceleration or deceleration of the vehicle becomes equal to or more than a predetermined value, or the like. The operational state detecting unit 59 invalidates the manipulation of the switch unit 12 for a predetermined time after it is determined that the predetermined operational state is brought about based on the signal output from the operational state detection sensor 53.

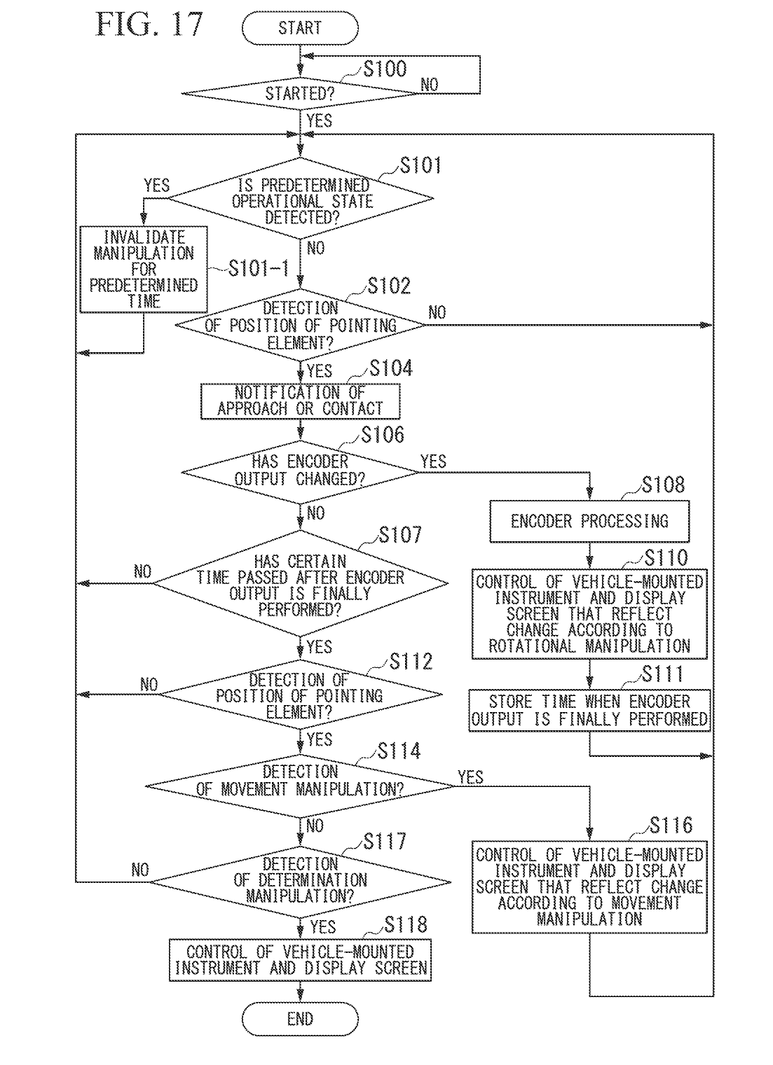

Processing performed in the seventh embodiment will be described with reference to FIG. 17. FIG. 17 is a flowchart illustrating an example of a flow of the processing in the present embodiment. In FIG. 17, the same symbols will be certain to the processing procedure that performs the same processing as in the aforementioned FIG. 10. Additionally, the processing procedure described in the aforementioned FIG. 10 will be omitted.

If the signal of the start switch 20 is input, the operational state detecting unit 59 determines whether or not the predetermined operational state is brought about based on the signal output from the operational state detection sensor 53 (Step S101). When the predetermined operational state is brought about, the manipulation of the switch unit 12 is invalidated for a predetermined time (Step S101-1), and the processing returns to Step S101.

In the manipulating device 10 of the present embodiment described above, the operational state detecting unit 59 invalidates the manipulation of the switch unit 12 for a predetermined time after it is determined that the predetermined operational state is brought about based on the signal output from the operational state detection sensor 53. Therefore, the manipulation of the switch unit 12 is allowed only when the vehicle is in a safe state, which can contribute to safe driving. Additionally, an operator's erroneous manipulation of the manipulating device can be prevented.

### Eighth Embodiment

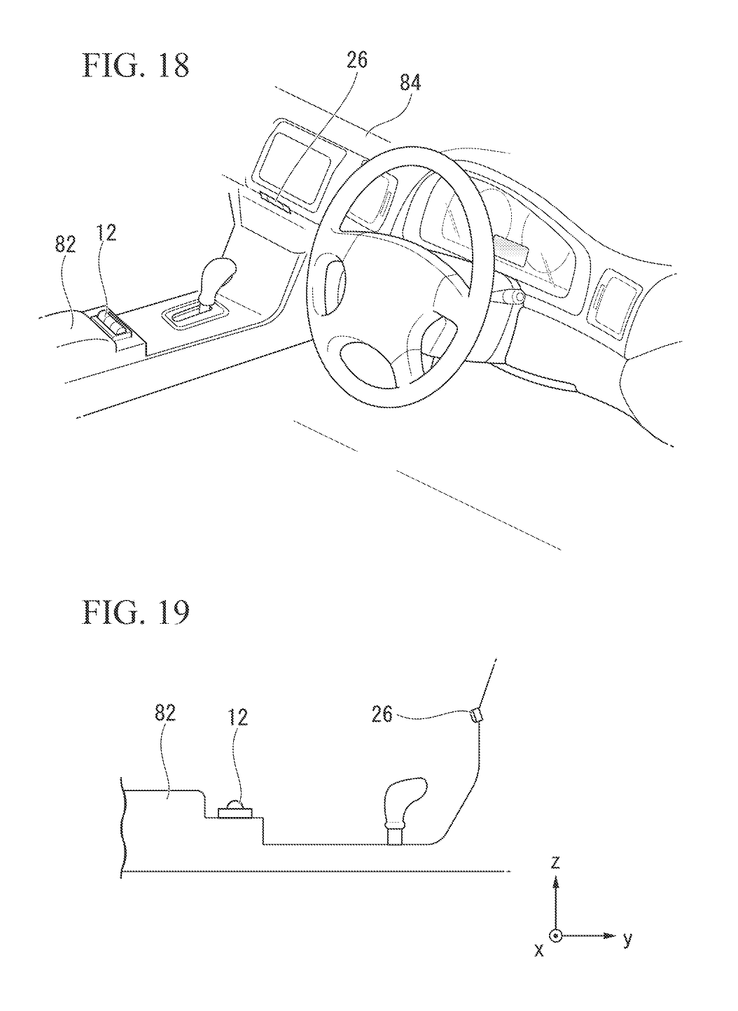

Hereinafter, a manipulating device 10 to which the present embodiment is applied will be described with reference to FIGS. 18 and 19. FIG. 18 is a view illustrating an example of an external appearance configuration of the manipulating device 10 related to an eighth embodiment of the invention. FIG. 19 is a side view illustrating an example of an external appearance configuration of the manipulating device 10 related to the eighth embodiment of the invention. The manipulating device 10 to which the present embodiment is applied is different in that the start switch 20 and the switch unit 12 are arranged in a center console 82 instead of the arrangement of the start switch and switch unit in the steering wheel 14.

The switch unit 12 is arranged within a range where the switch unit can be manipulated, in the center console 82 of the vehicle, in a state where a driver is seated in a driver's seat. Additionally, the switch unit 12 just has to be arranged at a position where the operator of the manipulating device 10 can manipulate the switch unit 12. Moreover, the switch unit 12 may be arranged on a dashboard 84, an armrest (not illustrated) on a window side, or the like as long as the arrangement in which the operator of the manipulating device 10 can manipulate the switch unit is provided.

Additionally, the manipulating device 10 to which the present embodiment is applied is different from the first embodiment in that a depth camera to be described below is provided as the position detecting sensor 26. Additionally, the present embodiment is different from the first embodiment in that the axial position detecting unit 50 processes a signal output from the depth camera 26 (to be described below), which is the position detecting sensor 26, to control the vehicle-mounted instrument 62 and the display unit 19.

The “depth camera” is, for example, a camera that has an image pick-up function, further has a function of acquiring information on the distance to each object, acquires information on the distance of a photographed area to each object, and outputs a signal corresponding to the acquired distance information. Additionally, the position detecting sensor 26 of the present embodiment may be a 3D camera, an infrared thermography device, or the like including a function of physically recognizing physical information on the pointing element in a predetermined area and acquiring a change in the physical information on the pointing element.

The axial position detecting unit 50 processes a signal output from the depth camera 26, and calculates the distance from the depth camera 26 to each object. For example, when a signal is output from the depth camera 26, the axial position detecting unit 50 computes the distance to an object from the output signal, and calculates the distance from the depth camera 26 to each object. Moreover, when there is any manipulation of the manipulating device 10 by the pointing element, the movement direction and the movement distance of the pointing element are calculated and signals corresponding to the calculation results are output to the instrument control unit 52 and the display control unit 54. The “manipulation” herein means the approach or contact of the pointing element with respect to the rotating member 22, the movement of the pointing element in an up-down direction or a left-right direction in an approaching state and in a contacting state, and the movement of the pointing element that can be recognized by the position detecting sensor 26 (pseudo-manipulation). This specific pseudo-manipulation and a predetermined control may be matched with each other, and a control corresponding to the rotational manipulation, the movement manipulation, or the determination manipulation may be executed by the pseudo-manipulation. Additionally, the position detecting sensor 26 may include a function of physically recognizing physical information on the pointing element in a predetermined area and acquiring a change in the physical information on the pointing element. Therefore, the arrangement of the position detecting sensor 26 just has to be an arrangement in which the fact that the pointing element has approached or contacted the switch unit 12 through an operator's manipulation can be recognized, and when the pointing element has performed the movement manipulation, a change in physical information in the movement manipulation can be recognized, and the position detecting sensor 26 just has to be appropriately arranged in a relationship with the arrangement of the switch unit 12.

Since the processing procedure of performing the processing in the present embodiment is the same as, for example, that of the aforementioned FIG. 10, the description thereof will be omitted.

According to the manipulating device 10 of the present embodiment described above, the depth camera 26 is provided, and the axial position detecting unit 50 acquires the distance information on each object, and outputs the signal corresponding to the acquired distance information. Additionally, the axial position detecting unit 50 processes the signal output from the depth camera 26, and calculates the distance from the depth camera 26 to each object. Accordingly, the position of the pointing element can be detected without providing the rotating member 22 with the position detecting sensor 26.

Additionally, the instrument control and the screen control can be performed by the pseudo-manipulation performed by the operator with respect to the switch unit 12. Moreover, since the rotating member is not provided with the position detecting sensor 26, the configuration is simple, and the manufacture becomes easy.

Although the modes for carrying out the invention have been described above using the embodiments, the invention is not limited to such embodiments at all, and various modifications and substitutions can be added without departing from the scope of the invention.

What is claimed is:

1. A manipulating device comprising:
a rotating member having a rotating shaft and a predetermined width direction along the rotating shaft;
a display unit configured to display a menu configured by an array of a plurality of items or display a predetermined set value; and
a control unit configured to execute a first control of selecting an item from the menu according to a rotational manipulation of the rotating member or changing the set value,
wherein the manipulating device includes an axial position detecting unit configured to detect a position where a pointing element approaches or contacts the rotating member in a direction intersecting a rotational direction of the rotating member, and
wherein the control unit executes a second control different from the first control, according to the position detected by the axial position detecting unit.

2. The manipulating device according to claim 1,
wherein the second control is a selection of another menu that is present within the same hierarchy as the menu, or a selection of a menu that is present in a hierarchy different from that of the menu.

3. The manipulating device according to claim 1,
wherein the axial position detecting unit detects a continuous change in the position of the pointing element in a direction intersecting the rotational direction in a state where the pointing element has contacted the rotating member, as a movement direction in a state where the pointing element has approached or contacted the rotating member, and
wherein the control unit executes the second control according to the movement direction.

4. The manipulating device according to claim 1,
wherein the axial position detecting unit divides the rotating member into a plurality of areas in a direction of the rotating shaft, and detects the position of the approach or contact according to the presence/absence of the approach or contact of the pointing element with respect to the areas.

5. The manipulating device according to claim 1,
wherein the rotating member includes a conductive material, and
wherein the axial position detecting unit includes a capacitance sensor that is arranged so that the electrostatic capacity of the rotating member can be detected, and detects the approach or contact of the pointing element based on a change in the electrostatic capacity that changes as the pointing element approaches or contacts the rotating member.

6. The manipulating device according to claim 5,
wherein the rotating member includes:
a moderation feeling imparting mechanism configured to include ride-over portions that are provided at predetermined intervals in a circumferential direction and a click pin that abuts the ride-over portions with a predetermined biasing force and impart a feeling of moderation at a certain predetermined angle during the rotational manipulation of the rotating member,
and is electrically connected to the capacitance sensor via the click pin.

7. The manipulating device according to claim 1,
wherein the rotating member is arranged so that the rotating shaft is embedded in a predetermined attachment surface, and
wherein the axial position detecting unit includes a capacitance sensor that is arranged on the attachment surface and that is arranged at a position where the pointing element is capable of contacting the capacitance sensor when the rotating member is rotationally manipulated.

8. The manipulating device according to claim 7,
wherein the rotating member is arranged so that the whole rotating member is embedded in the attachment surface, and
wherein the capacitance sensor is arranged in a direction on an extension line of the rotating member in the rotational direction on the attachment surface.

9. The manipulating device according to claim 7,
wherein the capacitance sensor is arranged in a direction on an extension line of the rotating shaft of the rotating member on the attachment surface.

10. The manipulating device according to claim 4,
wherein the axial position detecting unit includes a pressure sensor that detects a force applied to the areas in a direction intersecting a circumferential surface of the rotating member, and detects the contact position of the pointing element based on a pressure that is generated as the pointing element rotationally manipulates or pressingly manipulates the circumferential surface.

11. The manipulating device according to claim 4,
wherein the rotating member is provided with irregularities so as to visually or haptically discriminate among the plurality of areas.

12. The manipulating device according to claim 1,
wherein the second control is not reflected in the control unit even if there is any change in a detection state using the axial position detecting unit while the rotational manipulation of the rotating member continues being detected.

13. The manipulating device according to claim 1,
wherein the rotating member is arranged within a range in which a driver's thumb can reach when gripping the steering wheel, in a spoke portion of a steering wheel of a vehicle.

14. The manipulating device according to claim 13,
wherein the control unit does not execute the first control or the second control in a state where the steering wheel is steered at an angle equal to or more than a predetermined angle, in a straight-ahead state of a vehicle or in a state where the steering wheel is steered at an angular velocity equal to or more than a predetermined angular velocity.

15. The manipulating device according to claim 1,
wherein the rotating member is arranged in a center console of a vehicle within a range where the rotating member is capable of being manipulated in a state where a driver is seated in a driver's seat.

16. The manipulating device according to claim 1,
wherein the control unit makes the display unit perform a display according to an approaching state before execution of the second control, when a state where the pointing element has approached the rotating member with predetermined spacing is detected by the axial position detecting unit before the pointing element contacts the rotating member.

17. The manipulating device according to claim 1,
wherein the axial position detecting unit is capable of detecting a pseudo-pressing manipulation based on the range of positions where the detected pointing element contacts the rotating member, and
the control unit executes a third control different from the first control and the second control according to the pseudo-pressing manipulation.

18. The manipulating device according to claim 17,
wherein the third control is a determination input for determining an item selected by the first control or the second control.

19. The manipulating device according to claim 18,
wherein the control unit executes the first control when the determination input is received in a case where the first control is item selection from the menu, and executes the first control before the determination input is received in a case where the first control is a change in the set value.

20. The manipulating device according to claim 1,
wherein, when the display unit and the rotating member are in predetermined reference states, a manipulation direction of the rotational manipulation and a manipulation direction of a movement manipulation caused by the approach or the contact coincide with selection directions according to the first control and the second control in the display unit.
